(19) United States
(12) Patent Application Publication
(10) Pub. No.: US 2024/0421505 A1
(43) Pub. Date: Dec. 19, 2024

(54) TERMINAL METAL FITTING

(71) Applicant: Yazaki Corporation, Tokyo (JP)

(72) Inventor: Syunsuke YAOITA, Makinohara-shi (JP)

(73) Assignee: Yazaki Corporation, Tokyo (JP)

(21) Appl. No.: 18/741,146

(22) Filed: Jun. 12, 2024

(30) Foreign Application Priority Data
Jun. 19, 2023 (JP) 2023-099924

(51) Int. Cl. H01R 4/18

(52) U.S. Cl. CPC H01R 4/184

(57) ABSTRACT

A terminal metal fitting includes a terminal metal fitting main body having a plate-like shape and including, on one surface, a conductor bonding portion to which a conductor portion of an electric wire is bonded, wherein a recessed region is provided in a surface of the terminal metal fitting main body, the surface being opposite to the conductor bonding portion.

### CROSS-REFERENCE TO RELATED APPLICATIONS

The present application is based on, and claims priority from Japanese Patent Application No. 2023-099924, filed on Jun. 19, 2023, the entire contents of which are incorporated herein by reference.

### TECHNICAL FIELD

The disclosure relates to a terminal metal fitting.

### BACKGROUND

As a method of connecting a conductor portion of an electric wire to a metal terminal, an ultrasonic bonding method has been known (see JP2006-172927 A). In such an ultrasonic bonding method, for example, an electric wire having an insulating sheath from which a conductor end portion formed of a plurality of core wires is exposed and a connection terminal formed by erecting two side walls from a bottom surface are prepared. Further, the conductor end portion is positioned on the bottom surface between the two side walls of the connection terminal, and ultrasonic vibration is applied while pressing with a horn. Consequently, the terminal and the conductor mutually slide, are plastically deformed, adhere to each other, and then are bonded to each other. Further, as a terminal subjected to an ultrasonic bonding, there has been known a terminal in which a protrusion is provided at a position connected to a conductor so as to increase a bonding area between the terminal and the conductor.

In order to achieve satisfactory bonding by ultrasonic bonding, it is effective to provide frictional heat or the like to induce plastic deformation of the materials to be connected to each other, thereby raising a temperature. However, when the terminal has a large plate thickness, a temperature of the terminal itself is less likely to be raised, and it is difficult to acquire required bonding strength. In other words, it is difficult to apply ultrasonic bonding to a terminal having a large plate thickness and obtain sufficient bonding strength.

### SUMMARY OF THE INVENTION

The present disclosure has been made in view of the problem in the related art. Further, an object of the present invention is to provide a terminal metal fitting including a terminal metal fitting main body having a plate-like shape, the terminal metal fitting being capable of acquiring sufficient bonding strength by ultrasonic bonding even when the terminal metal fitting main body has a large plate thickness.

A terminal metal fitting according to an aspect of the present disclosure includes a terminal metal fitting main body having a plate-like shape and including, on one surface, a conductor bonding portion to which a conductor portion of an electric wire is bonded, wherein a recessed region is provided in a surface of the terminal metal fitting main body, the surface being opposite to the conductor bonding portion.

According to the present disclosure, it is possible to provide a terminal metal fitting including a terminal metal fitting main body having a plate-like shape, the terminal metal fitting being capable of acquiring sufficient bonding strength by ultrasonic bonding even when the terminal metal fitting main body has a large plate thickness.

### BRIEF DESCRIPTION OF DRAWINGS

FIG. 1A is a perspective diagram illustrating one example of an electric wire having an end portion from which a conductor portion is exposed.

FIG. 1B is a diagram illustrating a state in which the conductor portion of the electric wire is ultrasonically bonded to a conductor bonding portion of the terminal metal fitting.

FIG. 2A is a perspective diagram illustrating one example of the terminal metal fitting according to the present embodiment.

FIG. 2B is a diagram of the terminal metal fitting, which is illustrated in FIG. 2A, from the rear side.

FIG. 2C is a cross-sectional diagram taken along the line A-A in FIG. 2B.

FIG. 3A is a perspective diagram illustrating one example of the terminal metal fitting according to the present embodiment.

FIG. 3B is a diagram of the terminal metal fitting, which is illustrated in FIG. 3A, from the rear side.

FIG. 3C is a cross-sectional diagram taken along the line B-B in FIG. 3B.

FIG. 4 is perspective diagram illustrating another example of the terminal metal fitting according to the present embodiment.

FIG. 5 is perspective diagram illustrating another example of the terminal metal fitting according to the present embodiment.

FIG. 6 is perspective diagram illustrating another example of the terminal metal fitting according to the present embodiment.

### DETAILED DESCRIPTION OF THE INVENTION

A terminal metal fitting according to the present embodiment is described below in detail with reference to the drawings. Note that the dimension ratios in the drawings are exaggerated for the convenience of the description, and may be different from the actual ratios.

The terminal metal fitting according to the present embodiment includes a terminal metal fitting main body having a plate-like shape and including, on one surface, a conductor bonding portion to which a conductor portion of an electric wire is bonded. Further, a recessed region is provided in a surface of the terminal metal fitting main body, the surface being opposite to the conductor bonding portion.

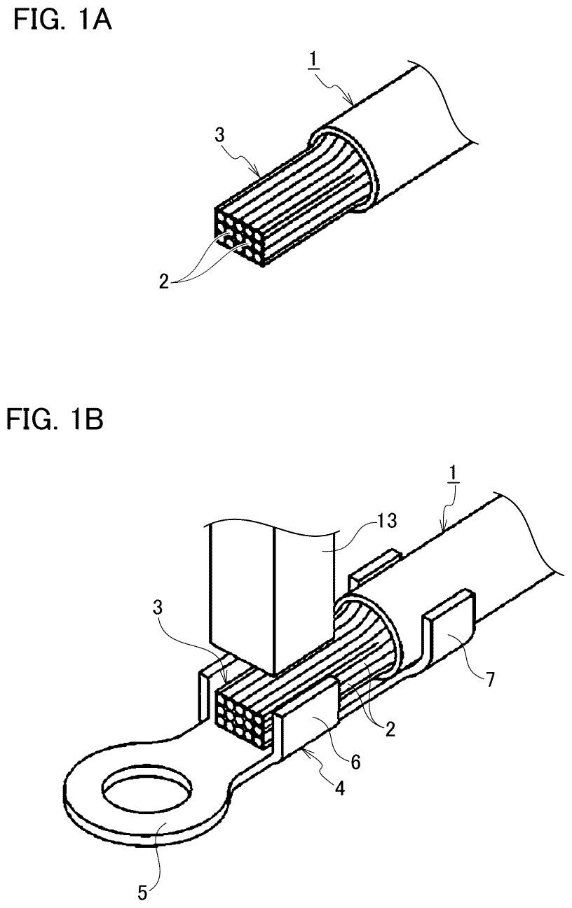

First, an ultrasonic bonding method is described. FIG. 1A illustrates an electric wire 1 to be bonded to a terminal metal fitting by ultrasonic bonding. At an end portion of the electric wire 1 illustrated in FIG. 1A, a conductor portion 3 formed of a plurality of core wires 2 is exposed. As the electric wire 1, an electric wire formed of a plastically deformable material (for example, an aluminum electric wire) is used. Further, the conductor portion 3 of the electric wire 1 is formed to have a flat plate-like shape by press molding.

FIG. 1B illustrates a state in which the conductor portion 3 of the electric wire 1 is placed on a conductor bonding portion 6 of a terminal metal fitting 4 and the conductor portion 3 and the conductor bonding portion 6 are ultrasonically bonded to each other. A pressurization/vibration horn 13 is arranged above the conductor portion 3, and the conductor portion 3 is bonded to the terminal metal fitting 4 by ultrasonic vibration applied by pressurization of the pressurization/vibration horn 13. For example, such ultrasonic bonding is described in Japanese Unexamined Patent Application Publication No. 2006-172927 A.

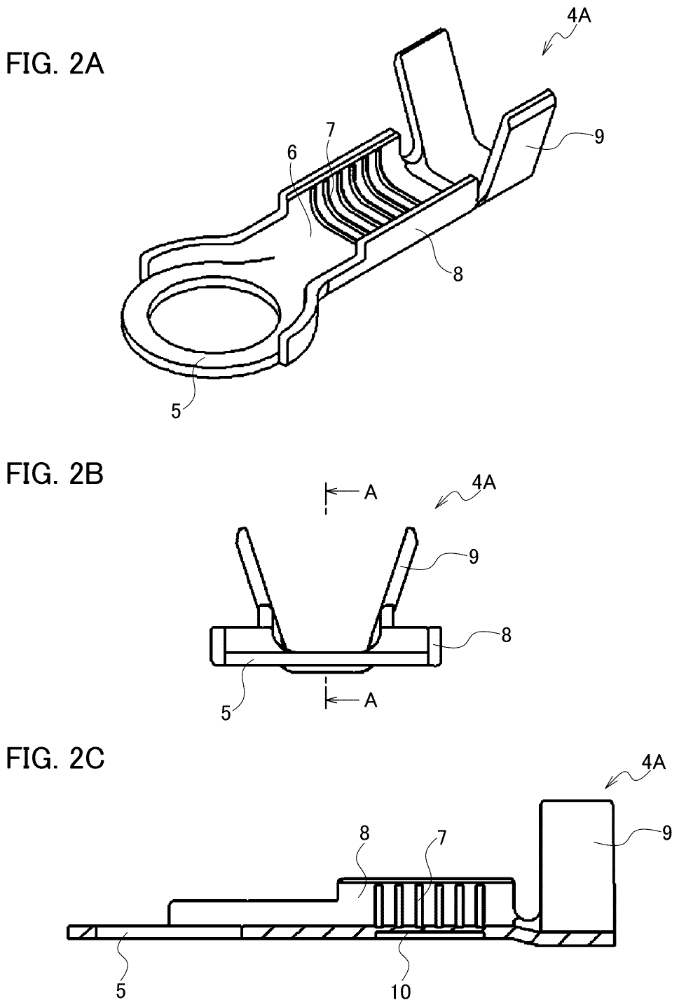

Next, a specific example of the terminal metal fitting according to the present embodiment is described. A terminal metal fitting 4A illustrated in FIG. 2A to FIG. 2C includes a ring terminal 5 at an end portion of a terminal metal fitting main body 8, and includes a crimping portion 9 at a rear portion. The conductor bonding portion 6 to which the conductor portion 3 of the electric wire 1 is bonded is arranged between the ring terminal 5 and the crimping portion 9. The ring terminal 5 is formed to have a ring hole, and is connected and fixed to a mating connection terminal by inserting a pin or a bolt into the ring hole. Further, the crimping portion 9 performs crimping in a state in which the electric wire 1 is placed on the terminal metal fitting main body 8, and thus an insulating covering portion of the electric wire 1 is fixed. A groove 7 extending in a direction intersecting with the electric wire 1 is formed in the conductor bonding portion 6. Both side edge portions of the conductor bonding portion 6 are bent. In other words, side walls are present on both the side edge portions of the conductor bonding portion 6. Further, the conductor portion 3 of the electric wire 1 is arranged on the inner side of the side walls.

As illustrated in FIG. 2C, a recessed region 10 is provided in a surface of the terminal metal fitting main body 8, the surface being opposite to the conductor bonding portion 6. The recessed region in FIG. 2C has a rectangular shape as viewed from the back surface side. In other words, the recessed region 10 having a plate thickness smaller than that in the periphery is formed in the surface being opposite to the conductor bonding portion 6. Thus, the terminal metal fitting main body 8 has a region having a small plate thickness in the conductor bonding portion 6, and the heat capacity is reduced as compared to a case in which the recessed region 10 is not formed. Consequently, when the conductor bonding portion 6 and the conductor portion 3 of the electric wire 1 are ultrasonically bonded to each other, frictional heat due to mutual sliding is increased, and a temperature is raised. As a result, plastic deformation is promoted, and bonding strength is increased. Moreover, the groove 7 is formed in the conductor bonding portion 6, and the heat capacity of the conductor bonding portion 6 is reduced as compared to a case in which the groove 7 is not present. Thus, the terminal metal fitting according to the present embodiment can acquire sufficient bonding strength by ultrasonic bonding even when the terminal metal fitting main body has a large plate thickness.

In view of reducing the heat capacity of the conductor bonding portion 6, it is preferred that the recessed region 10 be formed in the entire surface being opposite to the conductor bonding portion 6. The “entire region” is a region obtained by projecting a region to which the conductor portion of the electric wire is bonded onto the surface being opposite to the conductor bonding portion 6, and may be a region slightly larger than the region.

The recessed region 10 illustrated in FIG. 2C has a rectangular shape, but may have other shapes. The other shapes are not particularly limited as long as the heat capacity of the conductor bonding portion 6 can be reduced. For example, as viewed from the back surface side of the terminal metal fitting main body 8, a circular shape, an elliptical shape, an oblong shape, or the like may be adopted. Further, the recessed region may be formed of a plurality of recess portions. Examples of the plurality of recess portions include a triangle shape, a rectangular shape, a circular shape, an elliptical shape, and oblong shape.

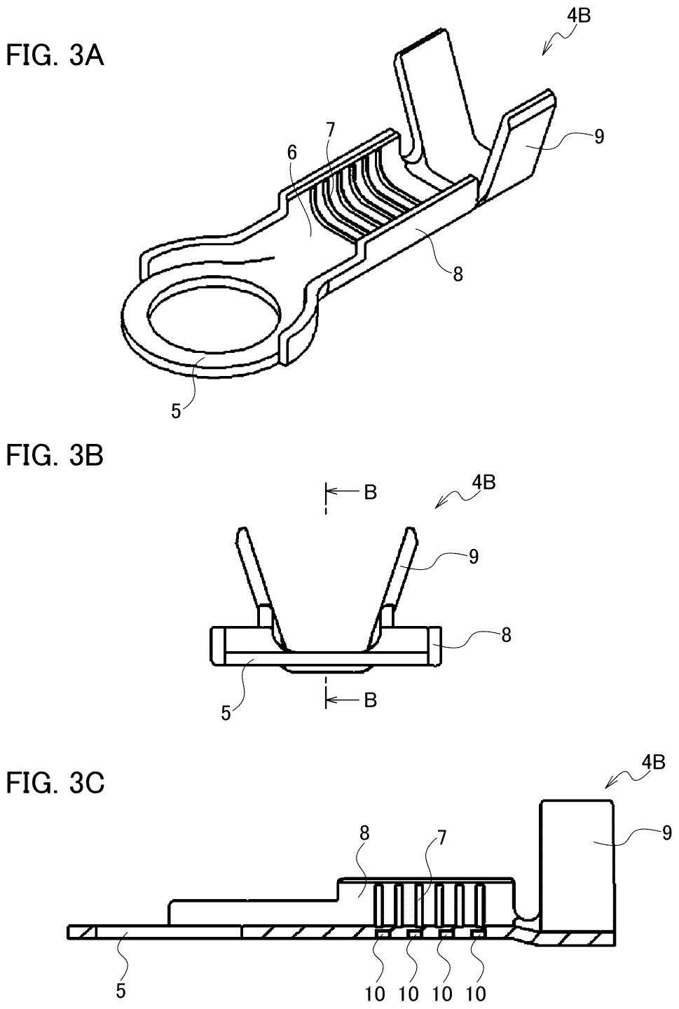

Description is made on another aspect other than the terminal metal fitting illustrated in FIG. 2A to FIG. 2C given above. A terminal metal fitting 4B illustrated in FIG. 3A to FIG. 3C is different from the terminal metal fitting 4A illustrated in FIG. 2A to FIG. 2C only in the recessed region 10 in the surface of the terminal metal fitting main body 8, which is opposite to the conductor bonding portion 6. Therefore, description is only made on the recessed region 10 being a difference. In the terminal metal fitting 4B illustrated in FIG. 3A to FIG. 3C, a plurality of recess portions in the recessed region 10 are formed to have a groove-like shape extending in a direction intersecting with the electric wire 1 as illustrated in FIG. 3C. With this configuration, similarly to the terminal metal fitting illustrated in FIG. 2A to FIG. 2C, in the conductor bonding portion 6 of the terminal metal fitting main body 8, the heat capacity is reduced, and bonding strength is improved. Meanwhile, the recessed region 10 is formed to have a groove-like shape, the region of the conductor bonding portion 6 where the plate thickness is small is reduced as compared to the terminal metal fitting 4C illustrated in FIG. 2A to FIG. 2C, and hence strength degradation can be suppressed. Thus, for example, unintended deformation due to a pressurizing force applied at the time of ultrasonic bonding can be prevented.

Even when the plurality of recess portions in the recessed region 10 are formed to have a groove-like shape illustrated in FIG. 3C, the groove may be a curved groove, instead of a linear groove. Moreover, the groove may be formed to have a lattice shape, a concentric shape, or a spiral shape.

In the terminal metal fitting according to the present embodiment, the heat capacity is reduced as the plate thickness of the conductor bonding portion of the terminal metal fitting is reduced, but mechanical strength is degraded as the plate thickness is reduced. Thus, it is preferred that the area and the depth of the recessed region be set so as not to reduce mechanical strength more than necessary while reducing the heat capacity.

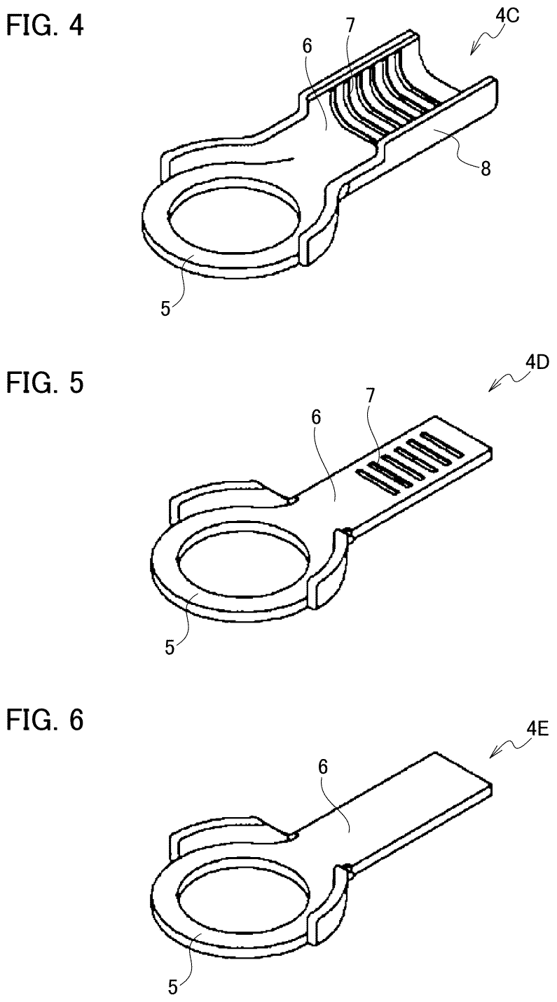

In FIG. 2A to FIG. 2C and FIG. 3A to FIG. 3C, the aspects including the crimping portion 9 are given, but the crimping portion 9 is not necessarily required. For example, as in a case of a terminal metal fitting 4C illustrated in FIG. 4, an aspect without the crimping portion 9 may be achieved. In the terminal metal fitting 4C, the recessed region 10 is also provided in the surface of the terminal metal fitting main body 8, which is opposite to the conductor bonding portion 6, as illustrated in FIG. 2C or FIG. 3C. Therefore, the heat capacity is reduced in the region during ultrasonic bonding, and bonding strength is improved.

Further, in FIG. 2A to FIG. 2C, FIG. 3A to FIG. 3C, and FIG. 4, the side walls are formed on the conductor bonding portion 6 of the terminal metal fitting main body 8, but the side walls are not necessarily required. For example, as in a case of a terminal metal fitting 4D illustrated in FIG. 5, the entire conductor bonding portion 6 may be only formed of a plate. In the terminal metal fitting 4D, the recessed region 10 is also provided in the surface of the terminal metal fitting main body 8, which is opposite to the conductor bonding portion 6, as illustrated in FIG. 2C.

Moreover, in FIG. 2A to FIG. 2C, FIG. 3A to FIG. 3C, FIG. 4, and FIG. 5, the groove 7 extending in the direction intersecting with the electric wire 1 is formed in the conductor bonding portion 6 of the terminal metal fitting main body 8, but the groove 7 is not necessarily required. For example, a groove may not be formed in the conductor bonding portion 6 as in a case of a terminal metal fitting 4E illustrated in FIG. 6. In the terminal metal fitting 4E, the recessed region 10 is also provided in the surface of the terminal metal fitting main body 8, which is opposite to the conductor bonding portion 6, as illustrated in FIG. 2C.

Meanwhile, in order to increase the bonding area with the conductor portion of the electric wire, a protrusion may be formed on the conductor bonding portion of the terminal metal fitting main body. In the present embodiment, even when such a protrusion is formed on the conductor bonding portion, the recessed region of the terminal metal fitting main body is formed in the surface being opposite to the conductor bonding portion, and hence interference therebetween is prevented.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A terminal metal fitting, comprising:
a terminal metal fitting main body having a plate-like shape and including, on one surface, a conductor bonding portion to which a conductor portion of an electric wire is bonded, wherein
a recessed region is provided in a surface of the terminal metal fitting main body, the surface being opposite to the conductor bonding portion.

2. The terminal metal fitting according to claim 1, wherein
the recessed region is formed in an entire region of the surface being opposite to the conductor bonding portion.

3. The terminal metal fitting according to claim 1, wherein
the recessed region is formed of a plurality of recess portions.

4. The terminal metal fitting according to claim 1, wherein
a groove is formed in the conductor bonding portion of the terminal metal fitting main body, the groove extending in a direction intersecting with the electric wire.
